(19) United States
(12) Patent Application Publication
(10) Pub. No.: US 2023/0027961 A1
(43) Pub. Date: Jan. 26, 2023

(54) REMOVABLE COMPOSITIONS AND METHODS OF USING SAME

(71) Applicant: Nanofabrica Ltd., Tel Aviv (IL)

(72) Inventors: Vered Italiano, Tel Aviv (IL); Eyal Shelef, Tel Aviv (IL); Jon Donner, Tel Aviv (IL); Hotam Lezerovich, Tel Aviv (IL); Katya Dlugach, Mabuim (IL); Gal Milshtein, Nes Ziona (IL); Tovit Neizer, Tel Aviv (IL); Assaf Green, Tel Aviv (IL)

(21) Appl. No.: 17/786,699

(22) PCT Filed: Dec. 17, 2020
(86) PCT No.: PCT/IL2020/051303

§ 371 Date: Jun. 17, 2022

Related U.S. Application Data
(60) Provisional application No. 62/949,549, filed on Dec. 18, 2019.

(51) Int. Cl. B29C 64/40; B33Y 30/00; B29C 64/245

(52) U.S. Cl. CPC B29C 64/40; B33Y 30/00; B29C 64/245

(57) ABSTRACT

A composition comprising a first layer in contact with at least one additional layer, wherein an outer surface of the composition is capable of binding a resin. Further, a building platform substrate comprising the composition of the invention, and a kit for releasing an object are provided.

### CROSS REFERENCE TO RELATED APPLICATIONS

This application claims the benefit of priority from U.S. Provisional Patent Application No. 62/949,549 filed on Dec. 18, 2019 entitled “REMOVABLE COMPOSITIONS AND METHODS OF USING SAME”, the contents of which are incorporated herein by reference in their entirety.

### FIELD OF THE INVENTION

The invention relates generally to the field of multilayer polymeric matrices.

### BACKGROUND

Three-dimensional (3D) printing may be used to fabricate a 3D object of almost any shape from a 3D model or other electronic data source primarily through manufacturing techniques such as layer-by-layer extrusion of a flowable part material (e.g. a resin).

The process of manufacturing a 3D object in a 3D printing system often requires the use of a support material (such as a printing platform). During the printing process sequential cross-sectional layers of the 3D object are deposited on a platform, where they undergo curing, to generate the 3D object. Generally, the printed 3D object is then separated from the support material.

Removal of the support material can be administered through several processes, including heating the support material to a temperature above its melting point, or manually removing the 3D printed object. However, the use of elevated temperatures and/or manual removal may compromise the mechanical integrity of the 3D part resulting in deformation or failure of the 3D printed objects.

Therefore, there exists a need for improved support materials for 3D printing, including support materials that can be removed in a more facile manner.

The foregoing examples of the related art and limitations related therewith are intended to be illustrative and not exclusive. Other limitations of the related art will become apparent to those of skill in the art upon a reading of the specification.

### SUMMARY

The following embodiments and aspects thereof are described and illustrated in conjunction with systems, tools and methods which are meant to be exemplary and illustrative, not limiting in scope.

In one aspect of the invention, there is provided a composition comprising a first layer in contact with at least one additional layer, wherein:

the first layer comprises a polymer characterized by a melting temperature (Tm) between 80 and 150° C.;

the at least one additional layer comprises any of: a water-soluble polymer, a polymer soluble in a polar organic solvent, and a polymer soluble in an acidic solution or any combination thereof.

In one embodiment, the first layer comprises a polymer selected from the group comprising: a polyolefin, polyhydroxyethyl methacrylate (polyHEMA), and polyurethane, including any combination or a copolymer thereof.

In one embodiment, the polyolefin comprises polypropylene (PP), polyethylene (PE) or both.

In one embodiment, the composition is characterized by a thickness of between 10 and 1000 micrometers.

In one embodiment, the composition further comprises an upper outer layer comprising an outer surface capable of binding a resin.

In one embodiment, the outer surface is characterized by a roughness below 5 nm.

In one embodiment, the composition is stable at a temperature less than 50° C., and upon exposure to UV radiation.

In one embodiment, the composition is stable at a temperature of less than 50° C., and upon exposure to UV radiation.

In one embodiment, the at least one additional layer is dissolvable in a composition comprising: a polar organic solvent, an aqueous solution, an acidic solution, or any combination thereof.

In one embodiment, the composition further comprises a bottom outer layer.

In another aspect, there is a building platform substrate comprising the composition of the invention.

In one embodiment, an exposed layer is removable by: (i) dissolution in a composition comprising an aqueous solution, or (ii) melting at a temperature between 80 and 150° C.

In one embodiment, the composition is stable upon removal of the exposed layer.

In one embodiment, an upper outer layer of the building platform substrate is capable of forming a non-covalent bond with a resin.

In another aspect, there is a kit for removing an object from the composition of the invention, or from the building platform of the invention, comprising a plurality of agents selected from the group consisting of: a polar organic solvent, an aqueous solution, and an acidic solution or any combination thereof.

In addition to the exemplary aspects and embodiments described above, further aspects and embodiments will become apparent by study of the following detailed description.

### DETAILED DESCRIPTION

According to one aspect there is provided a composition comprising a first layer in contact with at least one additional layer, wherein:

(i) the first layer comprises a polymer characterized by a melting temperature (Tm) between 80 and 150° C.;
(ii) the at least one additional layer comprises: a water-soluble polymer. In some embodiments, the composition further comprising an upper outer layer, wherein the outer layer comprises an outer surface capable of binding a resin.

In some embodiments, the composition comprises a plurality of layers. In some embodiments, the composition comprises two or more layers. In some embodiments, the composition comprises three or more layers. In some embodiments, the composition comprises four or more layers.

In some embodiments, each of the plurality of layers is in contact with at least one layer. In some embodiments, each of the plurality of layers is in contact with two layers.

In some embodiments, the term “layer”, refers to a substantially homogeneous substance of substantially uniform-thickness. In some embodiments, the term “layer”, refers to a polymeric layer.

In some embodiments, the first layer of the composition comprises a polymer characterized by a melting temperature (Tm) between 80 and 100° C., between 100 and 135° C., between 135 and 140° C., between 140 and 145° C., between 145 and 150° C., between 150 and 155° C., between 155 and 160° C., between 160 and 170° C., between 170 and 180° C., including any range or value therebetween.

In some embodiments, the first layer of the composition comprises a thermoplastic polymer.

In some embodiments, the first layer is removable by heating to a temperature above the Tm of the polymer (or of the layer) such as between 80 and 100° C., between 100 and 120° C., between 120 and 130° C., between 130 and 35° C., between 135 and 140° C., between 140 and 145° C., between 145 and 150° C., between 150 and 180° C., including any range or value therebetween.

In some embodiments, the first layer of the composition comprises a polymer selected from the group comprising: a polyolefin, a co-polyester, a polyether, polyethyleneglycol (PEG), polypropylene (PP), polyethylene (PE), polycarbonate, polycaprolactone (PCL), polylactic acid (PLA), polylactic-co-glycolic acid (PLGA), polyhydroxyethyl methacrylate (polyHEMA), and polyurethane, including any combination or a copolymer thereof.

Non-limiting examples of co-polyesters include but are not limited to: polyethylene terephthalate (PET), polycyclohexylenedimethylene terephthalate (PCT), polycyclohexylenedimethylene terephthalate (PCTG), polyethylene naphthalate (PEN), polytrimethylene terephthalate (PTT), and polybutylene terephthalate (PBT) or any combination thereof.

In some embodiments, the first layer is in contact with at least one additional layer. In some embodiments, the composition comprises the first layer in contact with at least one additional polymeric layer. In some embodiments, an additional layer is selected from the group comprising any of: a water-soluble polymer, a polymer soluble in a polar organic solvent, and a polymer soluble in an acidic solution.

In some embodiments, the composition comprises the first layer and at least two additional layers, wherein each layer is in contact with at least one subsequent layer and wherein the additional layers are as described hereinabove.

In some embodiments, the composition comprises the first layer and at least three additional layers, wherein each layer is in contact with at least one subsequent layer and wherein the additional layers are as described hereinabove.

In some embodiments, the composition comprises the first layer in contact with an additional layer comprising a water-soluble polymer. In some embodiments, the water-soluble polymer comprises any of: polyvinyl alcohol (PVA), poly (2ethyl-2-oxazoline), polyacrylic acid, carboxymethyl cellulose (CMC), a copolymer thereof, or any combination thereof.

In some embodiments, the water-soluble polymer is characterized by a solubility greater than 10 g/L in an aqueous solution.

In some embodiments, the water-soluble polymer is dispersible in an aqueous solution. In some embodiments, the layer comprising the water-soluble polymer is dissolvable or dispersible in an aqueous solution.

In some embodiments, the layer comprising the water-soluble polymer is dissolvable or dispersible in an aqueous solution at a temperature between 10 to 60° C., between 10 and 20° C., between 20 and 25° C., between 25 and 30° C., between 30 and 35° C., between 35 and 40° C., between 40 and 45° C., between 45 and 50° C., between 50 and 55° C., between 55 and 60° C., including any range or value therebetween.

In some embodiments, the layer comprising the water-soluble polymer is dissolvable or dispersible in an aqueous solution at a temperature of at least 30° C., at least 45° C., at least 40° C., at least 50° C., at least 55° C., at least 60° C., including any range or value therebetween.

In some embodiments, the water-soluble polymer is substantially dissolved or dispersed in an aqueous solution after a time period from 10 seconds to 10 hours. In some embodiments, the time period is at most 10 h, at most 5 h, at most 3 h, at most 1 h, at most 50 min, at most 40 min, at most 30 min, at most 20 min, at most 10 min, at most 1 min, including any range or value therebetween.

In some embodiments, a pH of the aqueous solution is from 6 to 8, from 6.5 to 7, from 7.5 to 8, including any range or value therebetween.

In some embodiments, the composition comprises the first layer in contact with an additional layer comprising a polymer soluble in a polar organic solvent. In some embodiments, the polymer soluble in a polar organic solvent is characterized by a solubility greater than 10 g/L.

In some embodiments, the polymer soluble in the polar organic solvent comprises: a polyacetate, a polysulfonamide, a copolymer thereof, or any combination thereof.

In some embodiments, a polar organic solvent comprises acetone, methanol, dimethyl formamide (DMF), N-methylpyrrolidone (NMP), dimethyl sulfoxide (DMSO), and acetonitrile (ACN) or any combination thereof.

In some embodiments, the additional layer is dissolvable in a polar organic solvent at a temperature between 10 to 60° C., between 10 and 20° C., between 20 and 25° C., between 25 and 30° C., between 30 and 35° C., between 35 and 40° C., between 40 and 45° C., between 45 and 50° C., between 50 and 55° C., between 55 and 60° C., including any range or value therebetween.

In some embodiments, the additional layer is dissolvable in a polar organic solvent after a time period from 10 seconds to 10 hours. In some embodiments, the time period is at most 10 h, at most 5 h, at most 3 h, at most 1 h, at most 50 min, at most 40 min, at most 30 min, at most 20 min, at most 10 min, at most 1 min, including any range or value therebetween.

In some embodiments, the composition comprises the first layer in contact with an additional layer comprising a polymer soluble in an acidic solution. In some embodiments, the polymer soluble in an acidic solution is characterized by a solubility greater than 10 g/L.

In some embodiments, the additional layer comprises a polymer dispersible in an acidic solution.

In some embodiments, the acidic solution is an aqueous solution. In some embodiments, an acidic solution comprises an acid, wherein the acid is a liquid at a temperature between 10 to 30° C.

In some embodiments, the acidic solution has a pH value between 0 and 5, between 0 and 1, between 1 and 2, between 2 and 3, between 3 and 4, between 4 and 5, including any range or value therebetween.

In some embodiments, the acidic solution comprises an acid selected from formic acid, acetic acid, trichloroacetic acid, trifluoroacetic acid.

In some embodiments, the polymer soluble or dispersible in an acidic solution comprises: a polyamide, a polyaniline, a copolymer thereof, or any combination thereof.

In some embodiments, the additional layer comprising the polymer soluble in an acidic solution is dissolvable or dispersible in an acidic solution at a temperature between 10 to 60° C., between 10 and 20° C., between 20 and 25° C., between 25 and 30° C., between 30 and 35° C., between 35 and 40° C., between 40 and 45° C., between 45 and 50° C., between 50 and 55° C., between 55 and 60° C., including any range or value therebetween.

In some embodiments, the additional layer is dissolvable or dispersible in an acidic solution after a time period from 10 seconds to 10 hours. In some embodiments, the time period is at most 10 h, at most 5 h, at most 3 h, at most 1 h, at most 50 min, at most 40 min, at most 30 min, at most 20 min, at most 10 min, at most 1 min, including any range or value therebetween.

In some embodiments, the composition comprises a bottom layer in contact with at least one layer. In some embodiments, the composition comprises a bottom layer in contact with a subsequent layer. In some embodiments, the bottom layer comprises an inner surface in contact with a subsequent layer and an outer surface. In some embodiments, the inner surface of the bottom layer is bound to a subsequent layer.

In some embodiments, an outer surface of the bottom layer faces a substrate (e.g. a printing stage). In some embodiments, an outer surface of the bottom layer has an adhesiveness property to a substrate, wherein the adhesiveness is as described hereinbelow. In some embodiments, an outer surface of the bottom layer is further in contact with an adhesive layer so as to provide the adhesiveness property to a substrate. In some embodiments, the adhesive layer is as described hereinbelow. In some embodiments, the outer surface of the bottom layer is bound to a substrate, wherein the substrate is as described hereinbelow.

In some embodiments, the adhesive layer is a high tack material comprising any one of: a polyacrylate, a polyvinyl ether, a silicone resin, a polyacrylic resin, and polyurethane or any combination thereof.

In some embodiments, the substrate is a solid substrate comprising any one of: a polymeric substrate, a glass substrate, and a metallic substrate, or any combination thereof. In some embodiments, the substrate comprises a build platform (e.g., a movable platen of a 3D printer).

In some embodiments, the composition comprises a bottom layer which is a first layer. In some embodiments, the bottom layer is in contact with one or more subsequent layers. In some embodiments, the composition comprises a bottom layer (i.e., the first layer) in contact with a second layer. In some embodiments, the first layer is any of the subsequent layers. In some embodiments, the composition comprises a first layer in contact with a second layer, and a third layer in contact with the second layer.

The numbers are used herein in a non-limiting fashion, so as to assign a relative position of a layer with respect to any additional layer (e.g. a preceding layer and a subsequent layer) within the composition. One skilled in the art will appreciate that the order and the number of layers may be altered in various embodiments and that the nomenclature “first layer” and “second layer” is used herein for ease of reference. For instance, in some embodiments a first layer is related to any layer which is not the bottom layer.

In some embodiments, the composition comprises an upper layer, having an inner surface facing a preceding layer of the composition and an outer surface. In some embodiments, the inner surface of the upper layer is in contact with a preceding layer of the composition. In some embodiments, the composition comprises the upper layer, having an outer surface facing a resin, wherein the resin is as described hereinbelow. In some embodiments, the upper layer comprises the water-soluble polymer.

In some embodiments, polymeric layers in contact with each other are held together by a covalent or a non-covalent bond, including any adhesive force.

The adhesive strength between two material layers can be measured by any of the methods known in the art, such as a peel test.

In some embodiments, the outer surface of the composition (e.g. the outer surface of the upper outer layer) has an adhesiveness property to an outer surface of a resin. In some embodiments, the outer surface of the composition is capable of binding a resin used in the fabrication of a 3D printed article. In some embodiments, the outer surface of the composition is capable of binding a resin in a molten state. In some embodiments, the outer surface of the composition is capable of binding a resin, wherein the resin is at a temperature above its melting point (Tm). In some embodiments, binding and adhesiveness is by forming a covalent bond, a non-covalent bond, or both.

In some embodiments, the outer surface of the composition has an adhesiveness property to an outer surface of a polymerized and/or cured resin. In some embodiments, the outer surface of the composition is capable of binding a polymerized and/or cured resin, wherein the polymerized and/or cured resin is in a solid state. In some embodiments, the outer surface of the composition is capable of binding an outer surface of a 3D printed article.

The term “resin”, as described herein is referred to a composition or a material applicable for 3D printing process, i.e. it can be polymerized or cured to provide a printed 3D article or object. In some embodiments, the resin is a thermally labile resin. In some embodiments, the resin is stable at a temperature of less than 80, less than 50, less than 40° C. Polymerization or curing can be carried out in any manner, such as for instance, irradiating with electromagnetic radiation having sufficient energy to initiate a polymerization or crosslinking reaction. In some embodiments, the resin comprises a monomeric chemical species, such as a chemical species having one or more functional groups or moieties that can react with the same or different functional groups or moieties of another monomeric chemical species to form one or more covalent bonds, such as in a polymerization reaction. A polymerization reaction, in some embodiments, comprises a free radical polymerization.

Optionally, the resin refers to a composition comprising at least one of: a monomer, an oligomer, a polymer or a mixture thereof, wherein the composition is at least partially polymerizable (e.g. via free-radical polymerization) upon exposure to light in the UV and/or visible range. In some embodiments, the resin comprises any methacrylate or acrylate resin which polymerizes upon exposure to UV light in the presence of a free radical photoinitiator. In some embodiments, the resin comprises one or more low molecular weight materials, such as methacrylates, dimethacrylates, triacrylates, and diacrylates, or any combination thereof.

In some embodiments, a photoinitiator comprises an alpha-cleavage type (unimolecular decomposition process) photoinitiator or a hydrogen abstraction photosensitizer-tertiary amine synergist, operable to absorb UV light, preferably between 200 nm and 400 nm or between 300 nm and 385 nm, to yield free radical(s).

In some embodiments, the resin comprises a photopolymer.

As used herein, the term “photopolymer” refers to a photo-polymerizable molecule being in form of a monomer, an oligomer, a polymer, or a mixture thereof. In one exemplary embodiment, the photo-polymerizable molecule comprises a photo-polymerizable unsaturated moiety (e.g. a vinyl group or an allyl group). In some embodiments, the photo-polymerizable molecule is photo-polymerizable or photo-curable at wavelengths ranging from about 200 nm to about 400 nm. Alternatively, the photo-polymerizable molecule is photo-polymerizable at visible wavelengths of the electromagnetic spectrum.

Non-limiting examples of photo-polymerizable molecules comprise: styrene, N-Vinylpyrrolidone, allyl acrylate, diacrylates (such as epoxides, urethanes, ethers, or esters functionalized by acrylate), tetrahydrofurfuryl methacrylate, triethylene glycol dimethacrylate, 2-phenoxyethyl methacrylate, lauryl methacrylate, ethoxylated trimethylolpropane triacrylate, tricyclodecane dimethanol diacrylate, 2-phenoxyethylacrylate, triethylene glycol diacrylate, a monofunctional aliphatic urethane acrylate, polypropylene glycol monomethacrylate, polyethylene glycol monomethacrylate, cyclohexane dimethanol diacrylate, tridecyl methacrylate, tri(meth)acrylates (e.g., 1,1-trimethylolpropane triacrylate or methacrylate, ethoxylated or propoxylated 1,1,1-trimethylolpropanetriacrylate or methacrylate, ethoxylated or propoxylated glycerol triacrylate, pentaerythritol monohydroxy triacrylate or methacrylate, and/or tris(2-hydroxy ethyl) isocyanurate triacrylate) or any combination thereof.

In some embodiments, the resin is applicable for manufacturing an article by 3D printing process. In some embodiments, the resin is applicable for manufacturing an article by a method selected from stereoliotgraphy (SLA), digital light processing (DLP), and low force stereolitography (LFS), Fused Filament Fabrication (FFF) or any combination thereof.

The terms SLA, DLP, FFF and LFS are known in the art and refer to various 3D printing methods for manufacturing three-dimensional objects in a layer by layer fashion using photochemical crosslinking.

As used herein the term “curing” refers to hardening a polymeric material by crosslinking of polymeric chain. Such crosslinking may result in the formation of a tridimensional polymeric network. Optionally, curing may refer to UV-induced crosslinking of the unsaturated moieties, such as carbon-carbon double bonds.

Non-limiting examples of resins comprise: an aliphatic polyester urethane acrylate oligomer, a urethane (meth)acrylate resin, a (meth-)acrylate resin, a (meth-)acrylate amine oligomeric resin, and a di(meth)acrylate ester of aliphatic cycloaliphatic or aromatic diols (such as butanediol, neopentyl glycol, 1,6-hexanediol, 1,4-dihydroxymethylcyclohexane, 2,2-bis(4-hydroxycyclohexyl)propane, hydroquinone, bisphenol A), a cycloaliphatic epoxy resin, a cyanate ester-based resin, a silicon polyurethane resin, and a dual cure resin (such as epoxy, silicon, etc.) or any combination thereof.

In some embodiments, the outer surface of the composition is characterized by a roughness of less than 1 μm, less than 0.9 μm, less than 0.8 μm, less than 0.7 μm, less than 0.6 μm, less than 0.5 μm, less than 0.4 μm, less than 0.3 μm, less than 0.2 μm, less than 0.1 μm, including any range or value therebetween.

The term “roughness” as used herein relates to the irregularities in the surface texture. Irregularities are the peaks and valleys of a surface. Roughness of a surface can be determined by Scanning Electron Microscope (SEM).

In some embodiments, the composition of the invention is between 1 μm and 10 cm thick. In some embodiments, the composition is characterized by a thickness from 1 to 10 μm, from 10 to 20 μm, from 20 to 30 μm, from 30 to 40 μm, from 40 to 50 μm, from 50 to 100 μm, from 100 to 150 μm, from 150 to 200 μm, from 200 to 300 μm, from 300 to 400 μm, from 400 to 500 μm, from 500 to 600 μm, from 600 to 700 μm, from 700 to 800 μm, from 800 to 900 μm, from 900 to 1000 μm, from 1000 to 2000 μm, from 2000 to 3000 μm, from 3000 to 4000 μm, from 4000 to 5000 μm, including any range or value therebetween.

In some embodiments, the terms “thick” or “thickness” including any grammatical form thereof, refer to an average thickness.

In some embodiments, the composition is a solid at a temperature between 0 to 30° C., between 10 to 30° C., between 20 to 30° C., between 25 to 30° C., between 30 to 60° C., between 60 to 100° C., including any range therebetween.

In some embodiments, the composition is solid at a temperature of less than 100° C., of less than 80° C., of less than 30° C., less than 28° C., less than 26° C., less than 24° C., less than 22° C., less than 20° C., less than 18° C., less than 15° C., less than 10° C., less than 5° C., less than 0° C., including any range or value therebetween.

Further, the composition of the invention described herein, in some embodiments, can have a melting point or a freezing point compatible with the operable temperature of a 3D printing system.

In some embodiments, at least a part of the composition has a melting point above 30° C., above 35° C., above 40° C., above 45° C., above 50° C., above 60° C., above 70° C., above 100° C., above 130° C., including any range or value therebetween.

In some embodiments, the composition is stable at a temperature of less than 30° C., less than 28° C., less than 26° C., less than 24° C., less than 22° C., less than 20° C., less than 18° C., less than 15° C., less than 10° C., less than 5° C., less than 0° C., including any range or value therebetween.

In some embodiments, the composition is compatible with any of 3D printing methods. In some embodiments, the composition is compatible with any of SLA, DLP, FFF and LFS. In some embodiments, the composition is compatible with a photo-chemical reaction, such as photo-crosslinking.

In some embodiments, the composition is substantially inert (i.e., non-reactive) to light irradiation. In some embodiments, the composition is substantially inert to UV radiation. In some embodiments, the composition is substantially inert to UV and/or visible light radiation.

In some embodiments, the composition is non-curable or does not polymerize upon exposure to UV and/or visible light radiation. In some embodiments, the composition is substantially devoid of chemical species having an unsaturated moiety, such as acrylate, methacrylate, or vinyl group.

In some embodiments, the composition comprises chemical species having an unsaturated moiety in an amount of less than 5% by weight, less than 1% by weight, less than 0.5% by weight, less than 0.1% by weight, based on the total weight of the composition.

In some embodiments, the composition is stable upon exposure to UV and/or visible light radiation.

As used herein the term “stable” refers to the capability of the composition to maintain its structural and/or mechanical integrity. In some embodiments, the composition is referred to as stable, if the composition is characterized by a mechanical integrity sufficient to provide a support for a 3D printed object. In some embodiments, the stable composition is configured to provide a support for a 3D printed object. In some embodiments, the composition is referred to as stable, if the composition substantially maintains its structural and/or mechanical integrity under conditions of a 3D printing process. In some embodiments, the stable composition is chemically inert to the conditions of a 3D printing process. The conditions of 3D printing process may comprise parameters such as operable temperature, deposition rate, UV and/or visible light irradiation. In some embodiments, the stable composition is rigid under 3D printing conditions.

In some embodiments, the composition is chemically inert to the resin in a molten state. In some embodiment, chemically inert is substantially devoid of covalent and/or non-covalent bond formation between a molten resin and the composition of the invention.

In some embodiments, the composition further comprises an additive. In some embodiments, the additive comprises any one of: a thickener, a binding agent, and a pigment or any combination thereof.

Various binding agent and pigments are known in the art.

Non-limiting examples of binding agents comprise polyvinyl alcohol (PVA), reactive PVA (such as acetoacetyl modified PVA), cationically modified PVA (such as amine or ammonium modified PVA), anionically modified PVA, hydrophilic group modified PVA, PVA-copolymer polyethylene oxide (PEO) and a starch-based binder, or any combination thereof.

Non-limiting examples of pigments comprise boehmite, pseudo-boehmite, silica (in precipitated, colloidal, gel, sol, and/or fumed form), cationic-modified silica (e.g., alumina-treated silica), cationic polymeric binder-treated silica, magnesium oxide, polyethylene beads, polystyrene beads, magnesium carbonate, calcium carbonate, barium sulfate, clay, titanium dioxide, gypsum, or any mixture thereof.

### 3D Printing Platform

According to another aspect of some embodiments of the present invention there is provided a building platform substrate comprising the composition of the invention. In some embodiments, the building platform substrate is a 3D printing platform.

In some embodiments, the building platform substrate is configured to provide a support for a 3D printed object. In some embodiments, the building platform substrate is sufficiently stable for use in a 3D printing process. In some embodiments, the building platform substrate has a sufficient mechanical stability (with response to parameters such as mechanical stress, deformation due to thermal expansion, UV/vis radiation) to provide a support for a 3D printed object.

In some embodiments, the building platform substrate comprises a bottom outer layer in contact with a substrate, wherein the substrate is as described hereinabove. In some embodiments, the building platform substrate comprises a bottom outer layer bound to the substrate. In some embodiments, the bottom outer layer is bound to the substrate via an adhesive layer, wherein the adhesive layer is as described hereinabove.

In some embodiments, the building platform substrate comprises an upper outer layer capable of forming a covalent and/or a non-covalent bond with a resin, wherein the resin is as described hereinabove. In some embodiments, the building platform substrate comprises an upper outer layer in contact with the resin. In some embodiments, the building platform substrate comprises an upper outer layer bound to the resin. In some embodiments, the upper outer layer of the building platform substrate is in contact or is bound with the resin in a molten state. In some embodiments, the upper outer layer of the building platform substrate is in contact with or is bound to a cured resin. In some embodiments, the upper outer layer of the building platform substrate is in contact with or is bound to a 3D printed object.

In some embodiments, the upper outer layer of the building platform substrate comprises a water-soluble polymer.

In some embodiments, the layers of the building platform substrate can be removed subsequently. In some embodiments, at least one layer of the building platform substrate can be removed independently from other layers.

In some embodiments, the building platform substrate comprises an exposed layer, being removable independently from other layers. In some embodiments, the exposed layer is at least partially removable by (i) dissolution in a composition comprising: a polar organic solvent, an aqueous solution, and an acidic solution, (ii) melting at a temperature between 30 and 80° C.

In some embodiments, the building platform substrate comprises one or more exposed layers at least partially removable by (i) dissolution in a composition comprising: a polar organic solvent, an aqueous solution, and an acidic solution, (ii) melting at a temperature between 80 and 150° C.

In some embodiments, the building platform substrate comprises a plurality of exposed layers being simultaneously removable, as described hereinabove.

In some embodiments, the exposed layer is in contact with an ambient. In some embodiments, the exposed layer is an upper outer layer. In some embodiments, the exposed layer is a bottom outer layer. In some embodiments, the exposed layer is an inner layer, which becomes exposed to the ambient upon removal of any of the outer layers.

In some embodiments, a residual layer(s) of the composition is stable upon removal of the exposed layer. In some embodiments, the residual layer is a layer remaining after removal of the exposed layer.

In some embodiments, the residual layer(s) is stable upon removal of the exposed layer, wherein stable is a described hereinabove. In some embodiments, the residual layer(s) maintains substantially its integrity upon removal of the exposed layer.

In some embodiments, one or more layers of the building platform substrate are selectively removable by any of: (i) contacting with a composition comprising: a polar organic solvent, an aqueous solution, and an acidic solution; (ii) heating to a temperature between 80 and 150° C.

In some embodiments, the layers of the building platform substrate can be removed sequentially, and the residual layer(s) of the composition are stable under the removing conditions (such as

In some embodiments, the exposed layer is removable by an aqueous solution and the residual layer(s) is stable (i.e. physically and/or chemically inert) to the aqueous solution.

In some embodiments, the exposed layer is removable by providing the composition to a temperature between 80 and 150° C. and the residual layer(s) is thermally stable at this particular temperature.

In some embodiments, the layers of the building platform substrate are physically and/or chemically inert to the aqueous solution, with the exception of the water-dissolvable layer. In some embodiments, the layers of the building platform substrate are physically and/or chemically inert to the polar organic solvent, with the exception of the layer dissolvable in a polar organic solvent. In some embodiments, the layers of the building platform substrate are physically and/or chemically inert to the acidic solution, with the exception of the layer dissolvable in an acidic solution. In some embodiments, the layers of the building platform substrate are physically and/or chemically inert at a temperature between 80 and 150° C., with the exception of the layer having a Tm between 80 and 150° C.

### Kit

According to another aspect of some embodiments of the present invention there is provided a kit for removing an object from the composition of the invention. In some embodiments, the kit comprises one or more agents selected from the group consisting of: a polar organic solvent, an aqueous solution, and an acidic solution or any combination thereof.

In some embodiments, the kit is for removing at least one layer of the composition. In some embodiments, the kit is for subsequent removing two or more layers of the composition. In some embodiments, the kit is for dissolving at least a part of the composition. In some embodiments, the kit is for dissolving at least a part of the 3D printing platform.

In some embodiments, the kit is for removing a 3D printed object from the 3D printing platform. In some embodiments, the kit is compatible with a 3D printed object. In some embodiments, a 3D printed object is substantially inert to one or more agents of the kit.

In some embodiments, the kit is sufficient for removing a 3D printed object from the building platform substrate within a time period ranging from 10 seconds to 10 hours. In some embodiments, the time period is at most 10 h, at most 5 h, at most 3 h, at most 1 h, at most 50 min, at most 40 min, at most 30 min, at most 20 min, at most 10 min, at most 1 min, including any range or value therebetween.

In some embodiments, the kit is applied selectively to one or more layers of the composition.

In some embodiments, a method of releasing a 3D printed object from the building platform substrate comprises contacting one or more agents of the kit with the 3D printing platform, thereby removing at least one layer of the composition.

In some embodiments, the method comprises applying the kit on at least a part of the outer layer in contact with the 3D printed object. In some embodiments, the kit is in contact with the building platform substrate for a time sufficient for removing at least one layer of the composition. In some embodiments, the kit is in contact with the building platform substrate for a time sufficient for removing the upper outer layer, thereby releasing the 3D printed object.

In some embodiments, the kit is in contact with the building platform substrate at a temperature between 30 and 80° C. In some embodiments, the kit is in contact with the building platform substrate at a temperature sufficient for removing the first layer, wherein the first layer comprises a polymer characterized by a melting temperature (Tm) between 80 and 150° C.

### General

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

As used herein, the term “substantially” refers to at least 80%, at least 85%, at least 90%, at least 92%, at least 95%, at least 96%, at least 97%, at least 98%, at least 99%, including any range or value therebetween. Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

1. A composition comprising a first layer in contact with at least one additional layer, wherein:
(I.) said first layer comprises a polymer characterized by a melting temperature (Tm) between 80° C. and 150;
(II.) said at least one additional layer comprises a water-soluble polymer.

2. The composition of claim 1, wherein said first layer comprises a polymer selected from the group comprising: a polyolefin, polyhydroxyethyl methacrylate (polyHEMA), and polyurethane, including any combination or a copolymer thereof.

3. The composition of claim 2, wherein said polyolefin comprises polypropylene (PP), polyethylene (PE) or both.

4. The composition of claim 1, wherein the composition is characterized by a thickness of between 10 micrometers (μm) and 1000 μm.

5. The composition of claim 1, further comprising an upper outer layer comprising an outer surface capable of binding a resin.

6. The composition of claim 5, wherein said outer surface is characterized by a roughness below 5 pm.

7. The composition of claim 1, wherein said water-soluble polymer comprises: polyvinyl alcohol (PVA), poly (2ethyl-2-oxazoline), polyacrylic acid, a copolymer thereof, or any combination thereof.

8. The composition of claim 1, wherein said composition is stable at a temperature less than 50° C., and upon exposure to UV radiation.

9. The composition of claim 1, wherein said composition is a solid at a temperature of 20° C. to 50° C.

10. The composition of claim 1, wherein said at least one additional layer is dissolvable in a composition comprising: a polar organic solvent, an aqueous solution, an acidic solution, or any combination thereof.

11. The composition of claim 1, wherein said composition further comprises a polymeric bottom outer layer.

12. A building platform substrate comprising the composition of claim 1.

13. The building platform substrate of claim 12, wherein an exposed layer is removable by: (i) dissolution in a composition comprising an aqueous solution, or by (ii) melting at a temperature between 80 and 150° C.

14. The building platform substrate of claim 13, wherein said composition is stable upon removal of the exposed layer.

15. The building platform substrate of claim 12, wherein an upper outer layer of said building platform substrate is capable of forming a non-covalent bond with a resin.

16. The building platform substrate of claim 12, wherein said building platform substrate is compatible with a 3D printing process.

17. A kit for removing an object from the composition of claim 1, or from a building platform substrate comprising the composition of claim 1, the kit comprising a plurality of agents selected from the group consisting of: a polar organic solvent, an aqueous solution, and an acidic solution or any combination thereof.
